(19) United States
(12) Patent Application Publication
(10) Pub. No.: US 2017/0138485 A1
(43) Pub. Date: May 18, 2017

(54) GAS SAMPLING BAG VALVE WITH SEALING RINGS MOVING BACK AND FORTH TO CONTROL LATERAL GAS NOZZLE

(71) Applicant: Huifeng TANG, Shanghai (CN)

(72) Inventor: Huifeng TANG, Shanghai (CN)

(21) Appl. No.: 15/323,441

(22) PCT Filed: Jul. 2, 2015
(86) PCT No.: PCT/CN2015/000485

§ 371 Date: Jan. 3, 2017

(30) Foreign Application Priority Data
Jul. 4, 2014 (CN) 201420369313.X

(51) Int. Cl. F16K 1/46; F16K 31/50; G01N 1/22; F16K 1/02

(52) U.S. Cl. CPC F16K 1/46; F16K 1/02; F16K 31/508; G01N 1/22

(57) ABSTRACT

A gas sampling bag valve with sealing rings moving back and forth to control a lateral gas nozzle is easy to operate and not prone to leaking gas. The connection portion between the valve and the membrane of the gas sampling bag comprises, from exterior to interior sequentially, a valve body with the lateral gas nozzle, a rubber gasket, the membrane of gas sampling bag and a bottom disc of a fastener, and the valve is fixed to the gas sampling bag by way of clockwise rotating the fastener. The sealing ring of top cover that controls a switch and is close to a knob prevents gas from leaking from a thread gap between the top cover control switch and the valve body.

### TECHNICAL FIELD

The present utility model relates to a gas sampling bag valve made of a polypropylene material; in particular to the gas sampling bag valve that is able to achieve valve on and off by way of allowing the clockwise and counterclockwise rotation of the valve top cover to drive the sealing rings of the top cover control switch to move back and forth within the lateral gas nozzle hole of the valve body.

### BACKGROUND ART

At present, the known gas sampling bag valve with lateral gas nozzle made of polypropylene material is typically formed by the following components in a series connection, a valve body with lateral gas nozzle, top cover control switch, rubber gasket and fastening member. The connection portion between. the valve and the membrane of the gas sampling bag comprises, from exterior to interior sequentially, a valve body with lateral gas nozzle, a rubber gasket, the membrane of gas sampling bag and a bottom disc of the fastening member; and the valve is fixed to the gas sampling bag by way of clockwise rotating the fastening member. The silicone gasket within the top cover control switch is used to control the gas exit on the fastening member, so as to achieve the open and closed states of the value. in the case when the top cover control switch is rotated counterclockwise, the silicone gasket provided within. the top cover control switch moves away from the gas exit on the fastening member, such that the valve is allowed to be in an open state; when the valve is in the open state, gas can be filled into or discharged from the gas sampling bag by means of the lateral gas nozzle of the valve body. in contrast, in the case when the top cover control switch is rotated clockwise, the silicone gasket provided within the top cover control switch moves towards and presses tightly against the gas exit on the fastening member, such that the valve is allowed to be in a closed state; when the valve is in the closed state, gas is enclosed and stored in the gas sampling bag. However, since the force applied by different people to rotate the control switch could be significantly different, the following problems may occur. When the top cover control switch is rotated clockwise, the rubber gasket may not be sufficiently pressed against the gas exit of the fastening member; as a result, the gas within the gas sampling bag may leak from the sampling bag. Moreover, the lower end of the exterior thread of the top cover control switch is provided with a sealing ring and typically this sealing ring is disposed close to the lower end of the exterior thread of the top cover control switch; when the top cover control switch is rotated counterclockwise, the foregoing sealing ring may be moved to the interior thread of the valve body; as a result, when gas is removed from the gas sampling bag to form a vacuum state therewithin, gas may leak from the gas formed between the exterior thread of the top cover control switch and the interior thread of the valve body.

### SUMMARY OF THE UTILITY MODEL

In order to overcome the deficiencies of inconvenient operation and gas leakage of the gas sampling bag valve with lateral gas nozzle, the present utility model provides a gas sampling bag valve with sealing rings moving back and forth to control lateral gas nozzle. This gas sampling bag valve is able to achieve valve on and off by way of allowing the clockwise and anticlockwise rotation of the valve top cover to drive the sealing rings of the top cover control switch to move back and forth within the lateral gas nozzle hole of the valve body.

The present utility model employs the following technical solution to solve the technical problem mentioned above: the top cover control switch has the following features in its shape: its overall length is 21.50 mm, at one end thereof, it has a rotation knob with a diameter of 18.00 mm and a thickness of 2.50 mm, an M12 exterior thread is next to the knob and the exterior thread has a length of 6.50 mm, a cylindrical body is next to the exterior thread, and the cylindrical body has a diameter of 8.50 mm and a length of 6.50 mm, a groove is next to the cylindrical body and the groove has a diameter of 6.50 mm and a length of 1.80 mm, another cylindrical body is next to the foregoing groove and this cylindrical body has a diameter of 8.50 mm and a length of 1.20 mm, another groove is next to the cylindrical body and the groove has a diameter of 6.50 mm and a length of 1.80 mm, a third cylindrical body is next to the foregoing groove and this cylindrical body has a diameter of 8.50 mm and a length of 1.20 mm; two sealing rings with an outer diameter of 10.00 mm and inner diameter of 6.00 mm are respectively provided for the two grooves of the top cover control switch, typically the inner diameter of the sealing ring is smaller than the cylindrical diameter of the groove by 0.20 mm to 0.60 mm. In addition, the part of the top cover control switch other than the knob is a cylindrical body with a length of 19.00 mm and there is a hole with a diameter of 4.90 mm and a depth of 19.00 mm in the center of this cylindrical body of the top cover control switch. Furthermore, the valve body has the following structural features: the overall length of the valve body is 28.50 mm, an M12 interior thread with a length of 6.50 mm is provided at one end of the valve body, a smooth inner cylindrical surface is next to the foregoing interior thread, this inner cylindrical surface has an inner diameter of 9.85 mm and a length of 12.50 mm, an M8 interior thread is next to the inner cylindrical surface, this M8 interior thread has a length of 9.00 mm, in addition, the outer diameter corresponding to the M8 interior thread is 14.00 mm and the outer diameter corresponding to other part of the valve body is 15.00 mm; moreover, a lateral gas nozzle hole with an inner diameter of 2.00 mm is provided in a position on the lateral side of the valve body, and this position is 14.00 mm from the M12 end of the valve body, the gas nozzle is perpendicular to the overall cylindrical body of the valve body and has a length of 30.00 mm and an outer diameter of 6.20 mm. The fastening member has an overall length of 20.00 mm, and a through hole of 2.00 mm is provided in the center of the fastening member, the fastening member has a cylindrical body on one end and the cylindrical body has an outer diameter of 4.00 mm and a length of 14.50 mm, an M8 outer thread is next to the foregoing cylindrical body and the M8 outer thread has a length of 8.00 mm, a round disc is next to the M8 outer thread and the disc has an outer diameter of 15.00 mm and a thickness of 1.50 mm. The sealing ring close to the knob on the top cover control switch is able to prevent gas from leaking form the threads between the top cover control switch and the valve body. When the top cover control switch is rotated clockwise or counterclockwise, the other sealing ring is allowed to move back and forth within the lateral hole on the valve body to achieve the open or closed state of the valve. Under normal condition, the cylindrical length between the sealing ring close to the knob of the top cover control switch and the M12 exterior thread of the top cover control switch is equal to or greater than the length of the M12 exterior thread of the top cover control switch; in addition, the length of the M12 exterior thread of the top cover control switch is consistent with the length of the M12 interior thread of the valve body. In this wat, at the moment when the M12 exterior thread of the top cover control switch starts to contact the M12 interior thread of the valve body^{,} prior to being screwed together, this sealing ring already functions to seal the gap between the foregoing two threads to prevent gas from leaking there between. In addition, when the top cover control switch is rotated clockwise to the end, the sealing ring close to the knob on the top cover control switch should be positioned on the side of the lateral gas nozzle hole of the valve body that is close to the knob; in addition, the sealing ring far away from the knob on the top cover control switch should be positioned on the side of the lateral gas nozzle hole of the valve body that is far away from the knob. Moreover, the distance between the position of the maximum diameter of the sealing ring and the closed edge of the hole should be from 0.10 mm to 3.00 mm. In this way, the gas nozzle is blocked by the sealing ring far away from the knob on the top cover control switch; as a result, the external gas cannot enter the gas sampling bag via the gas nozzle, and at the same time, the gas within the gas sampling bag cannot exit from the bag; that is to say, the valve is in a closed state. On the other hand, when the top cover control switch is rotated counterclockwise, the sealing ring far away from the knob on the top cover control switch moves towards the knob and accordingly, both sealing rings of the top cover control switch are located on the side of the valve body close to the knob of the top cover control switch; as a result, the valve is in an open state, hence gas can be filled into the gas sampling bag via the valve gas nozzle or has can be removed from the gas sampling bag via the valve gas nozzle. In this regard, the sealing ring far away from the knob on the top cover control switch is able to control the open and closed state of the valve. On the other hand, the sealing ring close to the knob on the top cover control switch is able to prevent gas leakage from the threads of the top cover control switch and the valve body. In particular, when the sealing ring far away from the knob on the top cover control switch has the position of its maximum diameter overlapping to the position of the center of the lateral hole of the valve body, in such a case, this sealing ring may not be able to fully block the lateral home of the valve body, and accordingly, the valve may still be in an open state, and at the same time, the sealing ring is not able to prevent gas leakage from the threads of the top cover control switch and the valve body. That's why the top cover control switch needs two separate sealing rings to assume the individual functions respectively. Furthermore, a 2.00 hole may be further provided in the center of the knob of the top cover control switch, and a silicone gasket with a diameter of 5.00 mm and a thickness of 2.50 mm may also be provided therein. In this way, the foregoing 2.0 mm hole on the knob of the top cover control switch may^{,} be used as a sampling hole for a sampling syringe.

The present utility model has the following advantageous effects: the the gas sampling bag valve provided in the present utility model is able to achieve valve on and off by way of allowing the clockwise and counterclockwise rotation of the valve top cover to drive the sealing rings of the top cover control switch to move back and forth within the lateral gas nozzle hole of the valve body. In this way, the present utility model solves the problems of the top cover control switch including inconvenient operation and gas leakage.

### BRIEF DESCRIPTION OF THE DRAWINGS

The present utility model will be further described in details in reference to the accompanying drawings and embodiments.

FIG. 1 shows three different views of the top cover control switch of the gas sampling bag valve with sealing rings moving back and forth to control lateral gas nozzle.

FIG. 2 is a schematic view of the structure of the valve body of the gas sampling bag valve with sealing rings moving back and forth to control lateral gas nozzle.

FIG. 3 shows three different views of fastening member of the gas sampling bag valve with sealing rings moving back and forth to control lateral gas nozzle.

FIG. 4 is a schematic view of the structure in which the top cover control switch, valve body and fastening member of the gas sampling bag valve with sealing rings moving back and forth to control lateral gas nozzle are assembled together.

FIG. 5 is a sectional view of the structure in which the top cover control switch, valve body and fastening member of the gas sampling bag valve with sealing rings moving back and forth to control lateral gas nozzle are assembled together.

### DESCRIPTION OF THE EMBODIMENTS

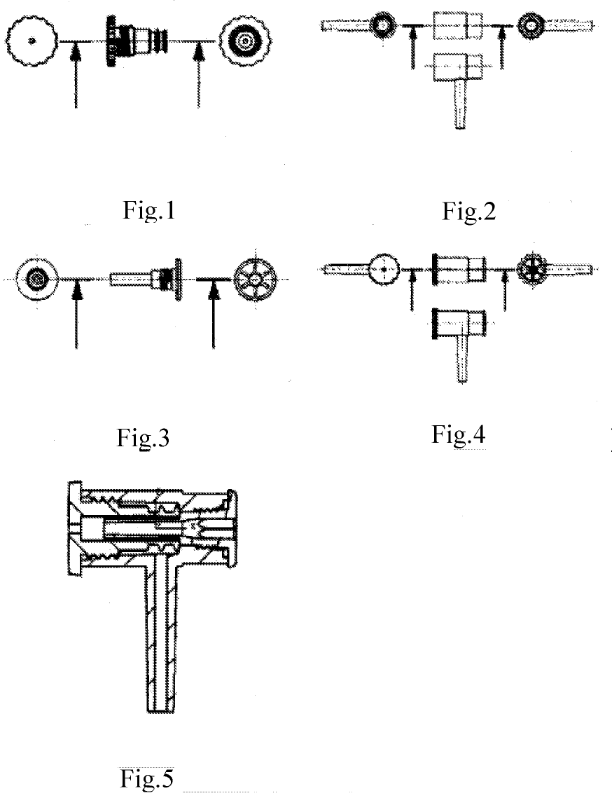

As shown in FIG. 1, a 2.00 mm hole is provided in the center of the knob of the top cover control switch, and a silicone gasket is provided therein. The foregoing is used for needle sampling. The two grooves are where the sealing rings will be disposed. Along the direction from left to right, the sealing ring on the first groove is provided to prevent gas leakage form the M12 interior thread and M12 exterior thread of the top cover control switch and the valve body. Typically, the length of the cylindrical surface on the left side of the groove plus a half of the length of the groove is greater than the length of the M12 exterior thread of the top cover control switch, in addition, the length of the M12 exterior thread of the top cover control switch is consistent with the length of the M12 interior thread of the valve body shown in. FIG. 2. In this way, the M12 interior thread and M12 exterior thread are in a tight engagement, and accordingly the sealing ring is able to prevent gas leakage from these threads. Moreover, when the top cover control switch is rotated clockwise to the end, the position of the center of the groove along the direction of left to right, as shown in FIG. 2, is on the side of the valve body that is far away from the knob of the top cover control switch; in addition, the position of the center of the foregoing groove is preferred to be within a distance of 0.10 mm to 3.00 mm from the closest edge of the hole. In the foregoing case, the valve is in a closed state. On the other hand, when the top cover control switch is rotated counterclockwise, the position of the maximum diameter of the sealing ring on the second groove along the direction of from left to right is moved to the side of the lateral hole close to the knob; in such a case, the valve is in an open state and gas can be filled into or removed from the gas sampling bag.

In the embodiment shown in FIG. 2, the valve body lateral gas nozzle is used for connecting to the outside via a latex tube. The lateral hole has a diameter of 2.00 mm and the corresponding outer diameter is 6.20 mm. As a result, it typically can accommodate the latex tube with an inner diameter of 4.00 mm and an outer diameter of 6.00 mm, or the latex tube with an inner diameter of 5.00 mm and an outer diameter of 7.00 mm. The left side opening is the M12 interior thread, which is used to receive the top cover control switch shown in FIG. 1. The right side opening is the M8 interior thread, which is used to receive the fastening member shown in FIG. 3.

As shown in FIG. 3, a 2.00 mm through hole is provided in the center of the fastening member. The gas filling and discharging operations for the gas sampling bag are both carried out through this through hole. The cylindrical body with an outer diameter of 4.00 mm and an inner diameter of 2.00 extends into the 4.90 mm hole on the top cover control switch shown in FIG. 1 and touches against the silicon gasket to facilitate a sampling operation. The inner hexagon hole on the right side of the fastening member functions to facilitate installation of the fastening member. In addition, the base disc surface on the right side of the fastening member has six grooves for facilitate form vacuum in the gas sampling bag. Moreover, the length of the M8 exterior thread of the fastening member is consistent with the length of the M8 interior thread of the valve body shown in FIG. 2.

FIG. 4 is a structural view showing both the top cover control switch and the fastening member have been mounted on the valve body.

FIG. 5 is a sectional view showing both the top cover control switch and the fastening member have been mounted on the valve body.

1. A gas sampling bag valve with sealing rings moving back and forth to control lateral gas nozzle, which is formed by a top cover control switch, a valve body having lateral gas nozzle, a rubber gasket and a fastening member, the top cover control switch is disposed within the left side opening interior thread of the valve body, the fastening member is disposed within the right side opening interior thread of the valve body, which is characterized in that a knob is provided at one end of the top cover control switch, an exterior thread is provided next to the knob, a cylindrical surface is provided next to the exterior thread, a groove is provided next to the cylindrical surface, another cylindrical surface is provided next to the groove, and another groove is provided next to the foregoing cylindrical surface, a third cylindrical surface is provided next to the foregoing groove, two sealing rings are respectively provided to the two grooves on the top cover control switch, in the case when the top cover control switch is in a closed state, the position of the sealing ring far away from the knob on the top cover control switch is on the side of the valve body lateral gas nozzle hole that is far away from the knob, and in the case when the top cover control switch is in an open state, the positions of the two sealing rings on the top cover control switch are on the side of the valve body lateral gas nozzle hole that is close to the knob.

2. The gas sampling bag valve with sealing rings moving back and forth to control lateral gas nozzle according to claim 1, characterized in that in the case when the top cover control switch is rotated clockwise to the end, the distance between the position of the maximum diameter of the sealing ring far away from the knob on the top cover control switch and the closest edge of the valve body lateral gas nozzle hole is within a range of from 0.10 mm to 3.00 mm.
